(19) United States
(12) Patent Application Publication
(10) Pub. No.: US 2021/0104923 A1
(43) Pub. Date: Apr. 8, 2021

(54) A Permanent Magnet Inside A Rotor Laminated Core

(71) Applicant: Continental Automotive GmbH, Hannover (DE)

(72) Inventor: Holger Fröhlich, Berlin (DE)

(73) Assignee: Continental Automotive GmbH, Hannover (DE)

(21) Appl. No.: 16/072,840

(22) PCT Filed: Jan. 26, 2017
(86) PCT No.: PCT/EP2017/051691

§ 371 Date: Jul. 25, 2018

(30) Foreign Application Priority Data
Jan. 28, 2016 (DE) 10 2016 201 281.9

(51) Int. Cl. H02K 1/27; H02K 15/03

(52) U.S. Cl. CPC H02K 1/276; H02K 15/03

(57) ABSTRACT

Some embodiments include a composite component for securing a permanent magnet inside a rotor laminated core of an electrical machine, the composite component comprising: a connecting element comprising a thermoplastic; and a permanent magnet secured inside the connecting element. The connecting element includes an outer fixing structure for securing the connecting element inside a receptacle of the rotor laminated core.

### CROSS-REFERENCE TO RELATED APPLICATIONS

This application is a U.S. National Stage Application of International Application No. PCT/EP2017/051691 filed Jan. 26, 2017, which designates the United States of America, and claims priority to DE Application No. 10 2016 201 281.9 filed Jan. 28, 2016, the contents of which are hereby incorporated by reference in their entirety.

### TECHNICAL FIELD

The invention relates to technologies for securing a permanent magnet or a plurality of permanent magnets within a rotor laminated core of an electrical machine.

### BACKGROUND

An electrical machine with internal permanent magnets generally contains a rotor which has a plurality of permanent magnets of alternating polarity around an outer circumference of a rotor laminated core of the rotor. The rotor can rotate inside a stator which generally contains a large number of windings and magnet poles of alternating polarity. The configuration of permanent magnets in electrical machines with internal permanent magnets is conventionally radially symmetrical, that is to say it exhibits symmetry with respect to an origin.

However, electrical machines of this kind can generate an undesired torque ripple which can lead to unwanted vibrations and noise.

Therefore, the permanent magnets in the rotor laminated core are conventionally beveled to reduce the torque ripple. This can be done, for example, in such a way that the permanent magnets are positioned at an axial angle relative to one another or the permanent magnets are rotated in steps. A beveled arrangement or offset arrangement of this kind is a proven technique which is used for reducing harmonics, the cogging torque, torque ripple and noise.

A continuous or stepwise offset arrangement can, for example, be provided. to achieve stepwise offset arrangement, laminated core stacks are initially fitted with permanent magnets during rotor construction. The respective laminated core stacks are then stacked or assembled at an axial angle relative to one another to form the complete rotor laminated core.

It is known to introduce permanent magnets into a rotor laminated core of a rotor of a permanent-magnet electrical machine. In this case, the permanent magnets are inserted into slots which are provided for them and are either clamped by additional elements or adhesively bonded in the slot openings. According to the prior art, adhesive bonding is the prevailing technology, but this requires complicated techniques during mounting and during recycling, such as, for example, when separating the permanent magnets from the motor components. Furthermore, the use of adhesive causes considerable expenditure in that, depending on the adhesive used, appropriate safety requirements have to be met due to any solvents or the like which may be evaporated.

Irrespective of the design of the electrical machine, securing the permanent magnets is of huge importance, particularly in the case of buried permanent magnets on account of the large forces and torques which occur, for example the centrifugal force and the start-up torque. Securing the permanent magnets in the appropriate slots or receptacles (pockets) by adhesives, such as epoxy resins or silicone materials (silicone elastomers and silicone resins), is common. However, there is a risk with adhesives of this kind that the adhesive will not fully and uniformly wet the corresponding joining surface of the magnet receptacle of the rotor or stator and therefore good adhesion between the permanent magnet and the laminated core will not be achieved. Non-uniform adhesion can lead to non-uniform mechanical loading of the laminated core. This can entail deformation of the laminated core and detaching of the permanent magnets.

Based on the above, new methods have been developed, such as clamping and calking the permanent magnets in the slot, and also the use of clamping elements, for example which are composed of plastic. Although such methods simplify the recycling process, they are often difficult to implement in respect of mounting, owing to a lack of flexibility, because relatively large tolerances must be bridged. Other known methods, in particular a weak press-fit, often do not provide sufficient security at high rotation speeds and vibration loading, as are specified, for example, for belt and crankshaft starter generators.

### SUMMARY

Proceeding from the above, the teachings herein may be used for securing a permanent magnet or a plurality of permanent magnets inside a rotor laminated core of an electrical machine, with an aim to overcome the abovementioned disadvantages. A particular aim is to make possible a simple design of a rotor which can be produced in a cost-effective manner. A further aim is to ensure precise and permanent fixing or securing of the permanent magnets within the rotor laminated core even under high dynamic loading. Another aim is to allow recycling of rare-earths from electrical machines to be simplified.

For example, some embodiments may include a composite component (1) for securing a permanent magnet (2) inside a rotor laminated core (3) of an electrical machine, the composite component (1) comprising a permanent magnet (2) which is secured inside a connecting element (4) which is composed of a thermoplastic, wherein the connecting element (4) has an outer fixing structure (5) for securing the connecting element (4) inside a receptacle (7) of the rotor laminated core (3).

In some embodiments, the permanent magnet (2) is encapsulated by way of injection molding with the thermoplastic of the connecting element (4).

In some embodiments, the permanent magnet (2) is inserted into the connecting element (4).

In some embodiments, the fixing structure (5) further comprises: laminates (6), bulging transverse profiled portions (18), triangular transverse profiled portions (19), transverse profiled portions (20) which run away from one another at an acute angle against a mounting direction (M) of the composite component (1) inside the rotor laminated core (3), longitudinal profiled portions (21) which run away from one another in a conical manner against a mounting direction (M) of the composite component (1) inside the rotor laminated core, and/or convex side walls (22).

In some embodiments, the connecting element (4) is substantially cuboidal, wherein the fixing structure (5) is arranged on outer sides (9, 10) of the connecting element (4) which are situated opposite one another.

In some embodiments, the fixing structure (5) is arranged circumferentially on outer sides (9, 10) of the connecting element (4) which are situated opposite one another and on a further outer side (23) which is arranged between the outer sides (9, 10) which are situated opposite one another.

As another example, some embodiments include a rotor laminated core (3) for an electrical machine comprising a composite component (1) as described above.

As another example, some embodiments include an electrical machine comprising a rotor laminated core (3) as described above.

As another example, some embodiments include a method for producing a rotor laminated core (3) for an electrical machine, comprising the steps of: providing a plurality of permanent magnets (2), providing a stacked rotor laminated core (3) having receptacles (7) for the permanent magnets (2), and securing the permanent magnets (2) inside connecting elements (4) which are composed of a thermoplastic, wherein the connecting elements (4) each have an outer fixing structure (5) for securing the connecting elements (4) inside the receptacles (7) of the rotor laminated core (3). The permanent magnets (2) are either encapsulated by way of injection molding with the thermoplastic of the connecting element (4) or are inserted into the connecting elements (4).

### BRIEF DESCRIPTION OF THE DRAWINGS

Exemplary embodiments of the teachings herein are discussed in more detail below on the basis of the schematic drawings, in which:

FIG. 1 shows a perspective partial view of a rotor laminated core with a composite component accommodated therein, according to the teachings of the present disclosure;

FIG. 2 shows a perspective view of the composite component according to FIG. 1;

FIG. 3 shows a lateral sectional illustration of the composite component according to FIG. 1, without the rotor laminated core being illustrated, according to the teachings of the present disclosure;

FIG. 4 shows a lateral sectional illustration of the composite component according to FIG. 1 inside the rotor laminated core,

FIG. 5 shows a lateral partial sectional illustration of the rotor laminated core according to FIG. 1 with illustrated burrs for interlocking connection to the composite component,

FIGS. 6 to 12 show side views of further composite components with different fixing structures, according to the teachings of the present disclosure;

FIG. 13 shows a longitudinal sectional illustration of a hose-like hollow profile for providing a connecting element for a further composite component, according to the teachings of the present disclosure; and

FIG. 14 shows an enlarged view of a detail of an outer fixing structure of the hollow profile according to FIG. 13.

### DETAILED DESCRIPTION

Some embodiments include a composite component for securing a permanent magnet inside a rotor laminated core of an electrical machine comprising a permanent magnet which is secured inside a connecting element which is composed of a thermoplastic. In some embodiments, wherein the connecting element has an outer fixing structure for securing the connecting element inside a receptacle of the rotor laminated core. In some embodiments, the permanent magnet can be clamped inside the connecting element in a particularly secure manner. Furthermore, the permanent magnet may be particularly reliably protected against damage inside the connecting element. Furthermore, housing the permanent magnet inside the connecting element can reduce the risk of any magnet parts which have chipped off getting into the electrical machine. Furthermore, tolerances of the magnet geometry can be compensated for by the connecting element. In addition, recycling of the permanent magnets can be improved by it being possible, for example, for the permanent magnets to be removed from the connecting elements and the plastic of the connecting elements to be melted.

The use of thermoplastics provides that the component weight can be reduced together with an absence of distortion and a high degree of dimensional stability at the same time. Furthermore, the composite component comprising a connecting element which is composed of a thermoplastic has a high temperature resistance at a high long-term service temperature and a simultaneous high degree of mechanical loading. Furthermore, said composite component is particularly resistant to a large number of chemicals, mineral oils and fuels. In addition, the thermal and electrical conductivity can be influenced by additives.

The composite component can be introduced into the receptacle of the rotor laminated core by way of its fixing structure, which may be elastic. The receptacles may be punched out of individual metal sheets which form the rotor laminated core. The punching operation creates a cut face which is scored and can have gaps and/or burrs. The fixing structure can engage into the gaps and/or burrs. An interlocking connection can be produced between the fixing structure and the receptacle of the rotor laminated core in this way. Given appropriate dimensioning of the outer dimensions of the composite component and the receptacles of the rotor laminated core, a force-fitting connection can also be produced between the composite component and the receptacles of the rotor laminated core, wherein the composite component is pressed into the receptacle under pressure. In some embodiments, the composite component may comprise a magnet clip which makes possible structural advantages and also savings in respect of mounting.

In some embodiments, the permanent magnet is encapsulated by way of injection molding with the thermoplastic of the connecting element. This embodiment makes possible complete housing of the permanent magnet inside the connecting element. The encapsulation by way of injection molding further provides a high degree of freedom in respect of design and also a higher loading capacity of the composite component in the event of changes in temperature or shocks in comparison to assemblies made up of a plurality of individual parts. The use of thermoplastics for encapsulating the permanent magnet by way of injection molding further provides the advantage that the component weight can be reduced together with an absence of distortion and a high degree of dimensional stability at the same time.

In some embodiments, the permanent magnet is inserted into the connecting element. The connecting element may be, in particular, a hose-like hollow profile which is composed of a thermoplastic, e.g. with a profiled portion on its outer side. A semifinished product, for example a bar material or a continuous profile, which is brought to a desired dimension by a separating method can be used for the hollow profile in particular. The permanent magnet can then be inserted into the semifinished product which has been brought to the desired length.

In some embodiments, the fixing structure can comprise laminates, bulging transverse profiled portions, triangular transverse profiled portions, transverse profiled portions which run away from one another at an acute angle against a mounting direction of the composite component inside the rotor laminated core, longitudinal profiled portions which run away from one another in a conical manner against a mounting direction of the composite component inside the rotor laminated core, and/or convex side walls. Elements of this kind make possible a particularly reliable interlocking and/or force-fitting connection between the composite component and the rotor laminated core.

In some embodiments, the connecting element is substantially cuboidal, wherein the fixing structure is arranged on outer sides of the connecting element which are situated opposite one another. This embodiment is particularly suitable for cuboidal permanent magnets and, in this context, is particularly material-saving in respect of the plastic of the connecting element.

In some embodiments, the fixing structure can be arranged circumferentially on outer sides of the connecting element which are situated opposite one another and on a further outer side which is arranged between the outer sides which are situated opposite one another. This makes a contribution to particularly firm accommodation of the composite component inside the receptacle of the rotor laminated core.

In some embodiments, a rotor laminated core for an electrical machine comprises an above-described composite component. Since a large number of permanent magnets are typically accommodated within the rotor laminated core, the rotor laminated core can preferably have a plurality of receptacles for accommodating an above-described composite component according to the invention in each case. In some embodiments, an electrical machine comprises an above-described rotor laminated core which is a constituent part of a rotor of the electrical machine.

In some embodiments, a method for producing a rotor laminated core for an electrical machine comprises providing a plurality of permanent magnets and a stacked rotor laminated core having receptacles for the permanent magnets. The permanent magnets are secured inside connecting elements which are composed of a thermoplastic, wherein the connecting elements each have a fixing structure for securing the connecting elements inside the receptacles of the rotor laminated core, and wherein the permanent magnets are either encapsulated by way of injection molding with the thermoplastic of the connecting element or are inserted into the connecting elements.

In some embodiments, an above-described composite component having profiled surfaces is produced and firmly introduced in a force-fitting and interlocking manner into corresponding receptacles of a rotor laminated core or of a hollow profile. Individual permanent magnets can be manufactured in one working step with different properties and functions by the encapsulation by way of injection molding.

A composite component which is produced according to the methods described above may be particularly well-suited to tolerance compensation when inserting the permanent magnet or the composite component into the receptacles of the rotor laminated core. Furthermore, chipping-off can be avoided or ingress of chipped-off pieces into the electrical machine can be avoided by housing the permanent magnets inside the connecting element. The method is furthermore particularly well-suited to automated mounting of permanent magnets into the corresponding receptacles of the rotor laminated core, but also for simple plug-in mounting. In addition, particularly simple recycling is made possible by simply removing the composite component from the receptacles of the rotor laminated core and melting the plastic of the connecting element.

The encapsulation of individual permanent magnets by way of injection molding provides a particularly high degree of process reliability in comparison to other joining methods such as, for example, adhesive bonding methods or clamping methods and can be performed in semi-automated or fully automated manufacturing cells. Producing the composite component by encapsulation of metal parts by way of injection molding with thermoplastics in fully automatic manufacturing cells saves mounting costs and creates structural advantages.

Furthermore, magnet material/plastic connections can have a high loading capacity, provide a high degree of freedom in respect of design and can combine a plurality of functions in one component. Therefore, production of assemblies is made possible which otherwise can be constructed only by means of several individual joining processes, as a result of which cost savings are possible. Furthermore, a high degree of freedom in respect of design together with an additional functionality is made possible by encapsulation by way of injection molding with plastic. Furthermore, better results can be achieved with magnet material/plastic composite parts than assemblies joined using other methods in load tests (thermal cycling test and shock test). In addition, secure embedding of magnet material components is possible. Furthermore, greater process reliability in comparison to other joining methods such as, for example, adhesive bonding or clamping is made possible.

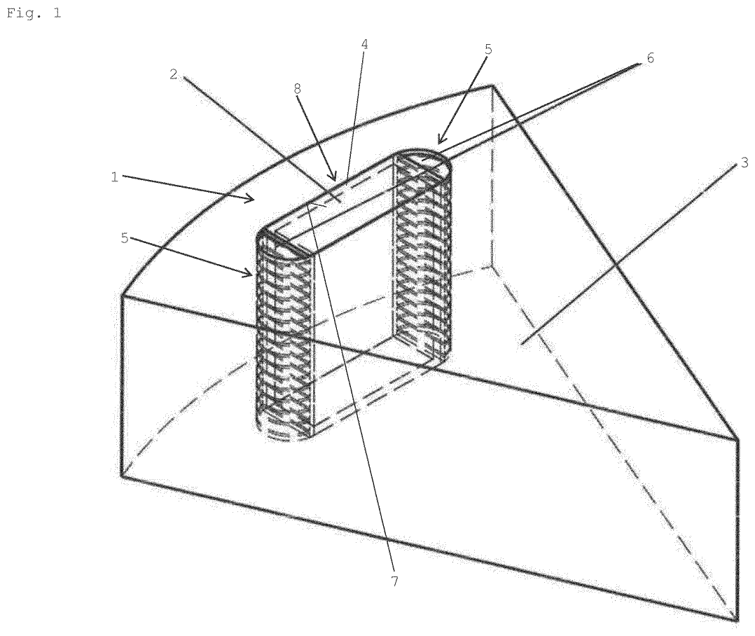

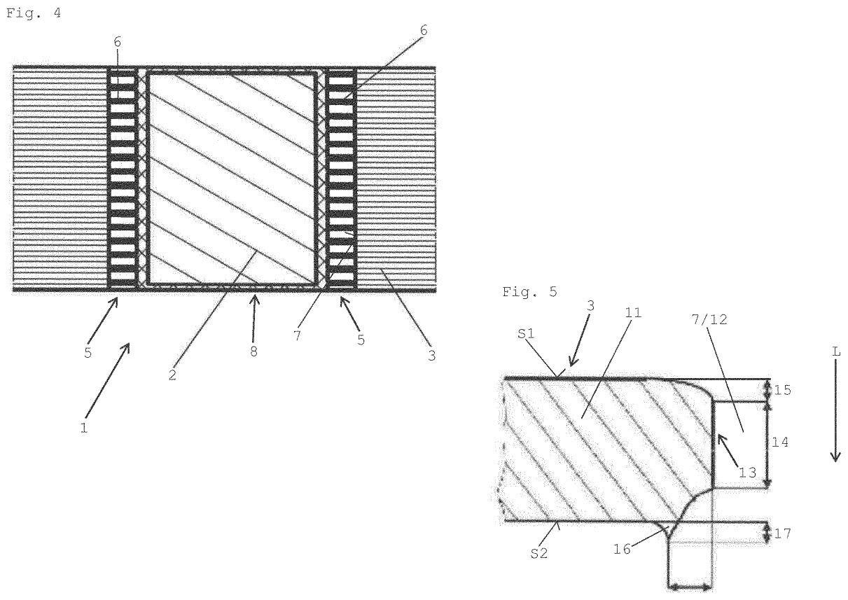

FIGS. 1 to 4 show a composite component 1 for securing a permanent magnet 2 inside a rotor laminated core 3 of an electrical machine, not illustrated. The permanent magnet 2 is secured inside a connecting element 4 which is composed of the plastic of the composite component 1, wherein the connecting element 4 has an outer fixing structure 5 in the form of elastic laminates 6 for securing the connecting element 4 and therefore also the entire composite component 1 inside a receptacle 7 of the rotor laminated core 3. The rotor laminated core 3 comprises yet further above-described receptacles 7 inside which—as is likewise described above—further composite components 1 are secured.

The connecting element 4 is substantially cuboidal. In the example shown, said connecting element has a central cuboidal middle element 8 which surrounds the likewise cuboidal permanent magnet 2. In the example shown, the permanent magnet 2 is encapsulated by way of injection molding with the thermoplastic material of the connecting element 4.

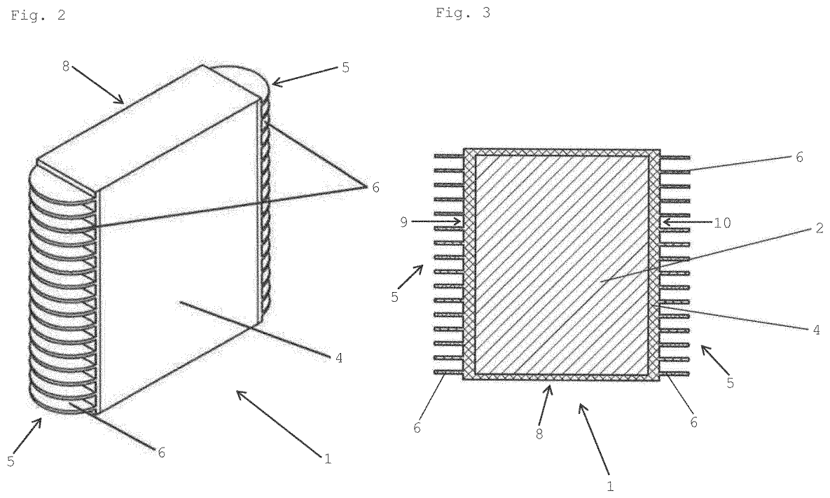

The fixing structure 5 is arranged on mutually opposite outer sides 9 and 10 (FIG. 3) of the middle element 8 and equidistantly next to one another. In this case, the laminates 6 are integrally connected to the middle element 8 of the connecting element 4 and have a semicircular shape.

FIG. 5 shows a portion of a metal sheet 11 of the rotor laminated core 3. An aperture 12 is punched into the metal sheet 11, said aperture connecting opposite end sides S1 and S2 of the metal sheet 11 to one another. A plurality of metal sheets 11 having apertures of this kind are stacked one above the other in a stacking direction L, so that the rotor laminated core 3 is produced. In this case, the apertures 12 of the respective metal sheets 11 are arranged in relation to one another in such a way that the receptacle 7 for the connecting element 4 and therefore also for the permanent magnet 3 is formed inside the rotor laminated core 3.

The punching operation creates a cut face 13 with a smooth cut portion 14 and an indent height 15, wherein the respective aperture 12 is partially scored and, in the example shown, has a burr 16 with a crack depth 17. The fixing structure 5 can engage in the burr 16 or in the gap before and after the smooth cut portion 14. An interlocking connection can be produced between the receptacle 7 of the rotor laminated core 3 and the fixing structure 5 of the composite component 1 in this way. The outer dimensions of the composite component 1 and of the apertures 12 or of the receptacle 7 of the rotor laminated core 3 are furthermore dimensioned in such a way that a force-fitting connection is produced between the composite component 1 and the receptacle 7 of the rotor laminated core 3, wherein the composite component 1 is pressed into the receptacle 7 under pressure.

FIG. 6 shows a further composite component 1 which differs from the composite component 1 shown by FIGS. 1 to 4 in that the fixing structure 4 does not have any laminates 5, but rather a plurality of bulging transverse profiled portions 18 which are arranged next to one another and equidistantly in relation to one another, as a result of which a particularly secure interlocking connection between the rotor laminated core 3 and the composite component 1 is made possible.

FIG. 7 shows a further composite component 1 which differs from the composite component 1 shown by FIGS. 1 to 4 in that the fixing structure 4 does not have any laminates 5, but rather a plurality of triangular transverse profiled portions 19 which are arranged next to one another and equidistantly in relation to one another, as a result of which a particularly secure interlocking connection between the rotor laminated core 3 and the composite component 1 is made possible.

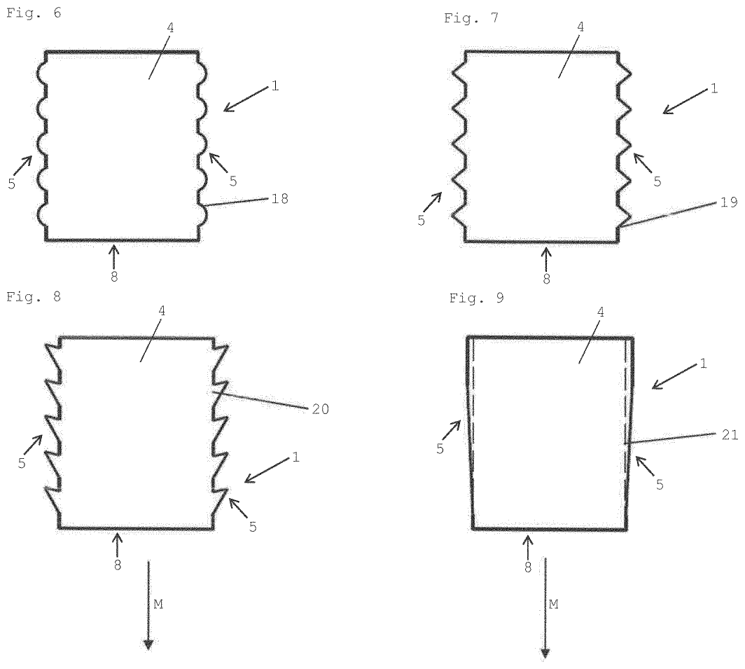

FIG. 8 shows a further composite component 1 which differs from the composite component 1 shown by FIGS. 1 to 4 in that the fixing structure 4 does not have any laminates 5, but rather transverse profiled portions 20 which run away from one another at an acute angle against a mounting direction M of the composite component 1 inside the rotor laminated core 3, it being possible for said transverse profile portions to engage particularly well between the burrs 16 of the metal sheets 11 of the rotor laminated core 3 (FIG. 5). The transverse profiled portions can furthermore form barbs which can particularly reliably prevent the composite component 1 moving out of the receptacle 4 of the rotor laminated core 3 against the mounting direction M.

FIG. 9 shows a further composite component 1 which differs from the composite component 1 shown by FIGS. 1 to 4 in that the fixing structure 4 does not have any laminates 5, but rather longitudinal profiled portions 21 which run away from one another in a conical manner against a mounting direction M of the composite component 1 inside the rotor laminated core 3, it being possible for said longitudinal profiled portions to be wedged particularly well inside the receptacle 7 of the rotor laminated core 3, as a result of which a particularly secure force-fitting connection between the composite component 1 and the rotor laminated core 3 can be made possible.

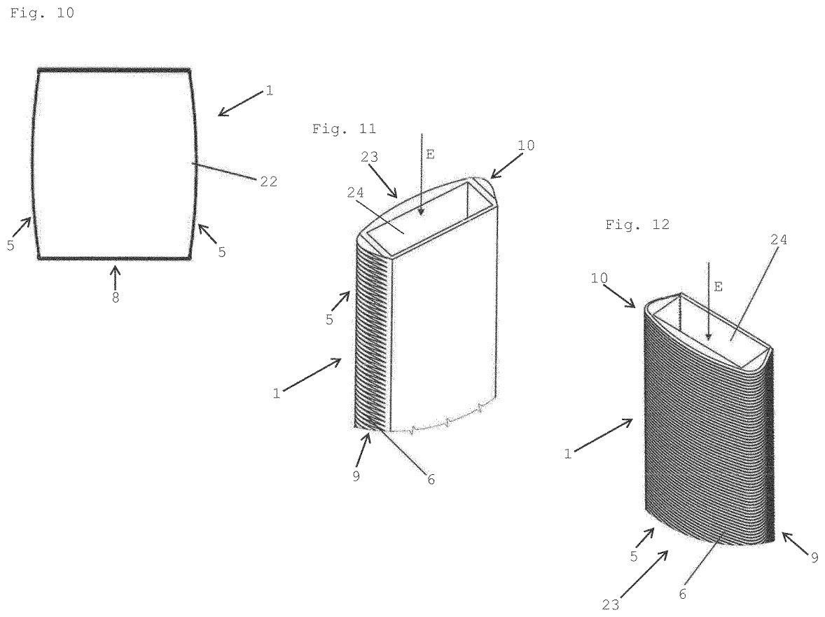

FIG. 10 shows a further composite component 1 which differs from the composite component 1 shown by FIGS. 1 to 4 in that the fixing structure 4 does not have any laminates 5, but rather convex side walls 22 which can be wedged particularly well inside the receptacle 7 of the rotor laminated core 3, as a result of which a particularly secure force-fitting connection between the composite component 1 and the rotor laminated core 3 can be made possible.

FIGS. 11 and 12 show a further composite component 1 which differs from the composite component 1 shown by FIGS. 1 to 4 in that the fixing structure 5, by way of laminates 6, is arranged circumferentially on outer sides 9, 10 of the connecting element 4 which are situated opposite one another and on a further outer side 23 which is arranged between the outer sides 9, 10 which are situated opposite one another. Furthermore, the permanent magnet is not encapsulated by way of injection molding with the thermoplastic of the connecting element 4, but rather is inserted into a receptacle 24 of the connecting element 4 in an insertion direction E.

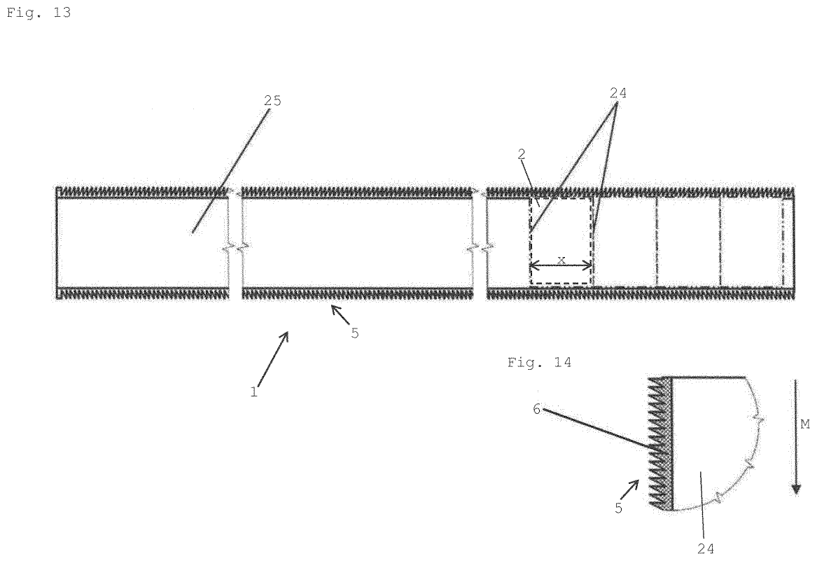

FIGS. 13 and 14 illustrate a possible way of producing a connecting element 4 for a composite component 1 according to the invention. The connecting element 4 which is composed of a hose-like hollow profile 25 is manufactured from a thermoplastic which is provided with a laminate-like profiled portion 5 on its outer side. A semifinished product, for example a bar material or a continuous profile, which is brought to a desired dimension, for example the length x, by a separating method can be used for the hollow profile 25 in particular. A permanent magnet 2 can then be inserted into a receptacle 24 of the hollow profile 25 which has been brought to the desired length. FIG. 14 further shows a mounting direction M of the connecting element 4 of the composite component 1 inside a rotor laminated core.

What is claimed is:

1. A composite component for securing a permanent magnet inside a rotor laminated core of an electrical machine, the composite component comprising:
a connecting element comprising a thermoplastic; and
a permanent magnet secured inside the connecting element;
wherein the connecting element includes an outer fixing structure for securing the connecting element inside a receptacle of the rotor laminated core.

2. The composite component as claimed in claim 1, wherein the permanent magnet is encapsulated by injection molding the thermoplastic of the connecting element.

3. The composite component as claimed in claim 1, wherein the permanent magnet is inserted into the connecting element.

4. The composite component as claimed in claim 1, wherein the outer fixing structure comprises at least one of:
Laminates;
bulging transverse profiled portions;
triangular transverse profiled portions;
transverse profiled portions running away from one another at an acute angle against a mounting direction of the composite component inside the rotor laminated core;
longitudinal profiled portions running away from one another in a conical manner against a mounting direction of the composite component inside the rotor laminated core; and/or
convex side walls.

5. The composite component as claimed claim 1, wherein: the connecting element is substantially cuboidal; and
the fixing structure is arranged on outer sides of the connecting element situated opposite one another.

6. The composite component as claimed in claim 5, wherein the fixing structure is arranged circumferentially on outer sides of the connecting element situated opposite one another and on a further outer side which is arranged between the outer sides situated opposite one another.

7. A rotor laminated core for an electrical machine, the rotor laminated core comprising a composite component for securing a permanent magnet inside a rotor laminated core of an electrical machine, the composite component comprising:
a connecting element comprising a thermoplastic; and
a permanent magnet secured inside the connecting element;
wherein the connecting element includes an outer fixing structure for securing the connecting element inside a receptacle of the rotor laminated core.

8. An electrical machine comprising:
a rotor laminated core comprising a composite component for securing a permanent magnet inside a rotor laminated core of an electrical machine, the composite component comprising:
a connecting element comprising a thermoplastic; and
a permanent magnet secured inside the connecting element;
wherein the connecting element includes an outer fixing structure for securing the connecting element inside a receptacle of the rotor laminated core.

9. A method for producing a rotor laminated core for an electrical machine, the method comprising:
securing a plurality of permanent magnets inside connecting elements;
providing a stacked rotor laminated core having receptacles for the connecting elements; and
inserting the connecting elements with the permanent magnets therein into the receptacle of the stacked rotor laminated core;
wherein the connecting elements comprise a thermoplastic;
the connecting elements each have an outer fixing structure for securing the connecting elements inside the receptacles of the rotor laminated core; and
the permanent magnets are either encapsulated by injection molding the thermoplastic of the connecting element or are inserted into the connecting elements.
